(19) United States
(12) Patent Application Publication
(10) Pub. No.: US 2011/0198470 A1
(43) Pub. Date: Aug. 18, 2011

(54) Hangaround for organizing portable articles

(76) Inventor: Binny Prasad Potter, Elkridge, MD (US)

(21) Appl. No.: 12/707,687

(22) Filed: Feb. 18, 2010

(51) Int. Cl. F16M 13/00

(52) U.S. Cl. 248/309.1

(57) ABSTRACT

A Hangaround is a device to organize a plurality of portable items of critical need. It has an attachment section and a holding section integrally made. The attachment section has an opening latch to attach the Hangaround to a support member. The holding section also has an opening latch. The holding member has a plurality of raised portions defining a trough between adjacent raised portions. The raised portions have openings to accommodate a fastener or a hook. Items to be stored are hanged on to the holding section.

### FIELD OF THE INVENTION

The present invention relates to a device to organize a plurality of items of critical need. More particularly, it concerns a holder to hang and securely hold a number of articles which can be easily located and removed for use as needed.

### FIELD OF THE INVENTION

Consumers continue to purchase more and more gadgets that they are completely dependent on. Some are technology related (cell phones, blackberry's, digital camera's . . . ), some are age related (bi-focal's, pills . . . ) and some are considered critical (lighters, billfolds/id's, sunglasses, calculator . . . ). Whether consumers are on the “go” or in their homes, they consistently misplace these items and are always “looking for them”. Whether they are in their car, shopping, golfing, biking, boating or lying around at the beach, they are always digging around to figure out where they put the critical items. As they become more dependent on these things and technology keeps creating more item dependencies, losing these items becomes a costly and mentally anguishing problem.

Unfortunately, it seems that the more items a consumer has, the more prevalent is their ability to lose, misplace or leave these items. In addition, when these items are multiplied by individuals residing in one household, there is an increased clutter in a household.

Thus, there is a critical need to organize and easily locate critical items with ease.

### SUMMARY OF THE INVENTION

The Hangaround is an organization and transport mechanism for managing “critical consumer items”. “Critical consumer items” can be any item that is needed by the consumer on a daily basis and usually an item that the consumer would not leave the household without. There is no limit to the type of user that would require and depend on this device. It is not age, gender or race sensitive. It can be used by any consumer that has critical items that they carry with them. A list of some critical consumer items is given in Table 1. This is just a sample of the types of items that can be “hung” on the Hangaround using accessory holders.

TABLE 1
List of Possible Critical Items

| | |
|---|---|
| Cell Phone | Golf Caddy |
| Eye Glasses | Medication |
| Notepad/pencil | IPod |
| Camera | Sunglasses |
| Calculator | Pocket Knife |
| Business Cards | Portable USB Storage Dev. |
| ID/Wallet/Change Purse | Lighter |
| Cigarettes | Keys |

The Hangaround is designed specifically for the purpose of allowing consumers to keep all their items neatly “hung” on the Hangaround so they can be easily located and stored. The Hangaround is small and portable and can be attached to virtually anything due to its flexible design and carabineer latch. The Hangaround helps consumers have these items at their fingertips no matter where they happen to be. It is a mechanism that allows you to safely reach and grab the items you need—only when you need them. Other items remain securely and neatly “hung” on the Hangaround so they are not lost or misplaced.

The Hangaround acts as a versatile organizer for items. The Hangaround consists of two sections—the first section called an attachment section and a second section called a holding section. The attachment section is on the top. The attachment section may be shaped in an oval, circular or any shape to allow versatility in attaching the Hangaround to a support member. A most likely list of support members where the Hangaround can be attached is given in Table 2. These are some traditional members where consumers might attach the Hangaround. With its flexible design, this list of support members could increase exponentially based on specific consumer needs.

TABLE 2
List of Possible Support Members

| | | |
|---|---|---|
| Car | Hunting Bags | Beach Umbrella |
| Back Packs | Desk Drawers | Shopping Carts |
| Dorm Rooms | Office/Cubicle Shelves | Class Rooms |
| Strollers | Purse | Belts |
| Closet Rods | Laptop Bags | Golf Carts |
| Boat | Jet Ski | Ladders |
| Camping Tents | Any Hook or Rod | Other Hangarounds |
| Door Knobs | Luggage | Bikes |

The attachment section has a carabineer latch that allows the attachment section to fit securely to the support member to which it is being attached. The attachment section is the area where the Hangaround attaches to a support member where the consumer wants access to their items. The support member where the Hangaround is attached is limitless (see table 2 for examples) because of the generic shape of the attachment section and the versatility of attaching it with the carabineer-style latch. Some common support members that the Hangaround might be attached by the consumer include shopping cart, inside cars, bike, backpacks, beach umbrella, boats and golf carts. The various Hangaround sizes also allow for the Hangaround to be attached to a belt hoop (smaller with fewer accessory hooks) and larger Hangarounds (called Hangaround Home Base) that allow for the connection of smaller Hangaround onto the one larger unit (about the size of an actual coat hanger). The Hangaround Home Base is designed for family's that have multiple Hangarounds. By hanging the Hangaround Home Base at a central “item dumping” or “gathering” place such as the front door, garage entrance or kitchen allows family members to attach their individual Hangarounds to the Home Base as they enter the home. This eliminates clutter and the searching for items later. The Hangaround Home Base is larger and would have similar raised portions with larger eyelet holes to allow for the individual Hangarounds to attach securely.

The second section of the Hangaround called the holding section is typically located below the attachment section. The most common shape of the holding section is triangular, however, this can change as the user requirements change. The holding section also has a carabineer latch. A portion of the holding section has a plurality of raised portions with eyelets or openings in the raised portions and a plurality of troughs between adjacent raised portions.

Various items to be stored or hanged are connected to the holding section by two different methods—(1) by using the opening carabineer latch or (2) by using small carabineer fasteners to connect to the raised portions eyelets provided on the holding section. Consumers would use method 1 for items that the consumer already owns that have accessory cases (such as an eyeglass case) with small attachment loops. The loops of these accessories would slide into the holding section using the opening at the carabineer latch. The accessory loop should slide into the troughs between the raised portions. These troughs are intended to keep accessories from sliding back and forth in the holding section. Consumers would use method 2 for accessory items that come with carabineer clips or for use with the accessories available from other sources such as, Hangaround Plus, LLC. The items would connect into the eyelets in the holding section. If there were more items than available eyelets, items could be slid into the troughs between the eyelets.

Both, the attachment section and the holding section have opening carabineer latches to prevent the Hangaround from accidental detachment from the support member to which the Hangaround is hanged on as well as to prevent detachment of various articles or items which are hanged on the holding section of the Hangaround.

The Hangaround is made of a metal such as aluminum. The Hangaround is formed in a variety of bright metallic colors. Different colors allow the consumers to easily identify their Hangarounds. The accessories used to hold the various items or articles are available in many fabrics (textures and patterns) and colors that allow the Hangaround to be more aesthetically pleasing and coordinate with the various metallic hues. The lightweight aluminum is durable enough to support the weight of a multitude of accessories. Heavy weight metals could be also used for making the Hangaround in larger sizes and strengths to support needs of specific businesses such as construction.

An additional critical component of Hangaround is the Identification area. This component is critical should the Hangaround be left “hanging” somewhere by the consumer. Since the Hangaround will have the consumers critical items attached to it, it is imperative that there is an ID area on the Hangaround so it can be easily identified and recovered. The ID area on the Hangaround is located at the point where the attachment section meets the holding section. In the current design, the ID area has flat circular surfaces as shown in the FIG. 1 section 40. One surface of the Hangaround ID section will be engraved with the Hangaround logo or can be customized for large purchases with custom engraving (i.e. company's could put their company logo on this side). The other flat circular surface with be engraved with the words “Name” and “Phone number”, with blank space below each of the words for the user to write their name and phone number with permanent marker.

Another optional item on the Hangaround is rubber sleeve that acts as a sleeve that slips onto the attachment section of the Hangaround. This rubber sleeve provides a nonstick grip to minimize the Hangaround from rattling or sliding in the place that it is attached (i.e. bike, golf cart, boat).

Potential users of the Hangaround are drivers, shoppers, bikers, students, vacationers, and anybody or everybody. The possibilities are limitless. The more gadget users become dependent on, the more they need quick access to them. The Hangaround is the solution for this. With all its custom accessories, the Hangaround can be used by anyone and any age group.

### BRIEF DESCRIPTION OF THE DRAWINGS

FIG. 1 is an assembled view of the Hangaround.

FIG. 1A is an assembled view of the Hangaround with sample Critical Items (70 & 75) connected to the trough (24) and to the raised portions (22) with a caribineer style clip.

FIG. 2A is view of the Attachment section with latch in the open position.

FIG. 2B is a view of the Attachment section with the latch is a closed position.

FIG. 3A is view of the Holding section with latch in the open position.

FIG. 3B is a view of the Holding section with the latch is a closed position.

FIG. 4 is an alternative embodiment of the Hangaround with a rubber sleeve.

### DETAILED DESCRIPTION OF THE INVENTION

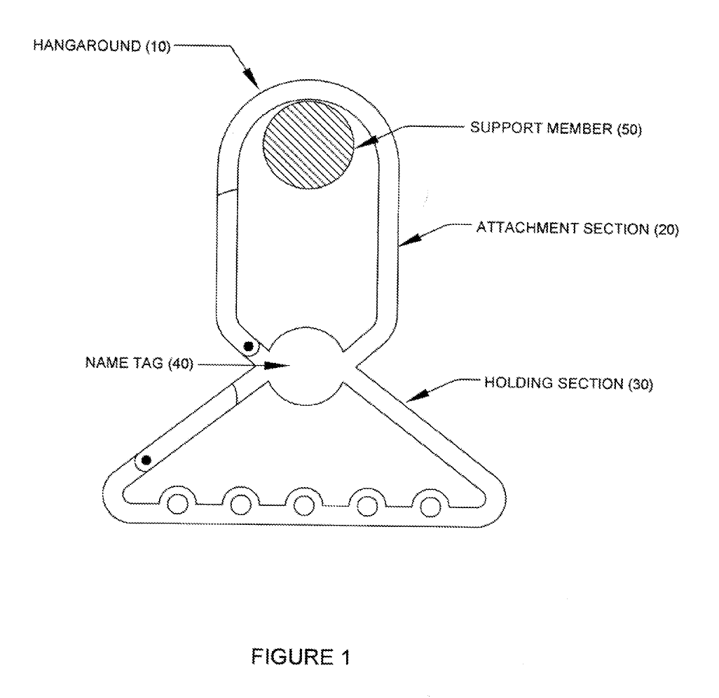

FIG. 1 shows an assembled view of the Hangaround 10 with its Attachment section 20 and its Holding section 30. The Attachment section and the holding section are integral with each other. An identification area is shown as numeral 40. The Attachment section is generally oval in shape but it could be circular, rectangular or any shape. The Attachment section is attached or hung on a support member such as a rail or rod shown as 50. The support member 50 could be of any shape.

FIG. 1A shows an assembled view of the Hangaround 10 with sample critical items attached by two methods. Attachment 70 is connected to the holding section by inserting the item loop through the carabineer latch on the holding section (30) and sliding it to the area between the raised portions (22) called the trough (24). Attachment 75 is connected to the holding section by using a carabineer clip that is connected through the eyelet holes in the raised portions (22).

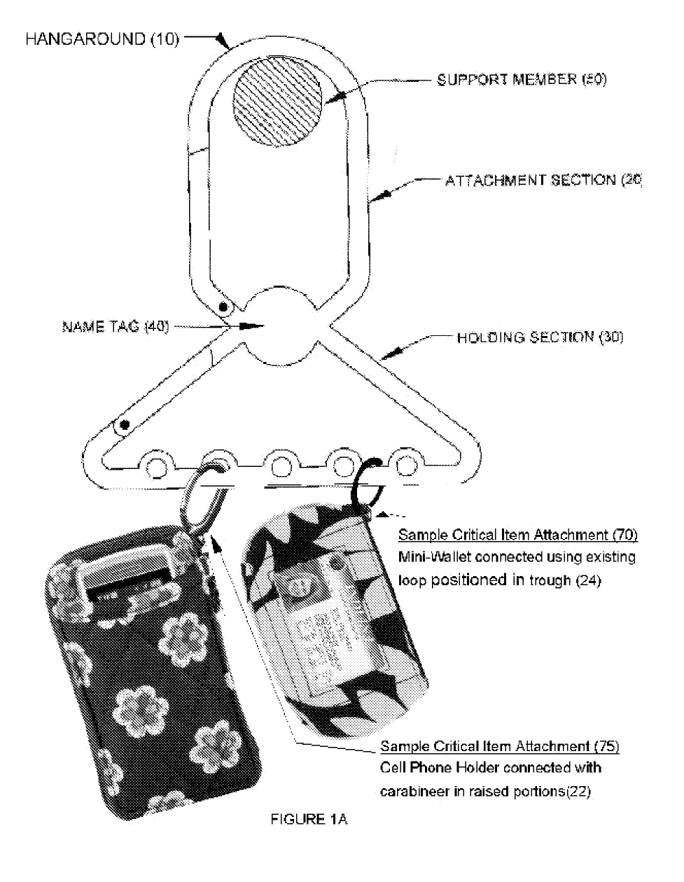

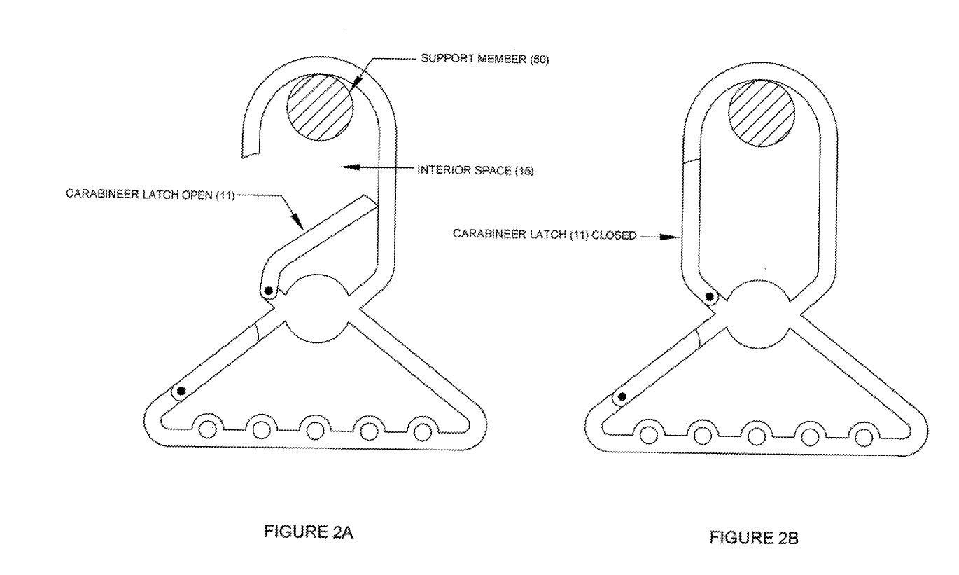

The Attachment section has a first interior space 15 and a first carabineer latch 11 opening into the first interior space 15 as shown in FIG. 2A. FIG. 2A shows the latch in an open position so that it can be attached to the Support Member 50. FIG. 2B shows the latch in a closed position. The latch is in the form of a gate with one end pivotally attached to the Attachment section. Another end of the latch closes on the Attachment member with a snap and in its closed position prevents the attachment section from any accidental removal from the Support Member 50.

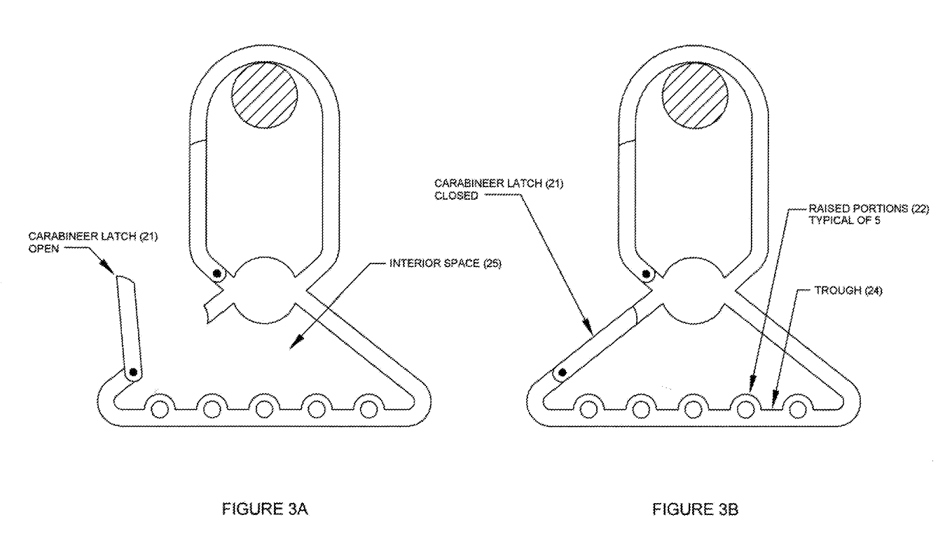

Details of the Holding section are shown in FIGS. 3A and 3B. The holding section has a second interior space 25 and a second carabineer latch 21 for providing an opening for the second interior space 25 as shown in FIG. 3A. FIG. 3A shows the latch in an open position so that various articles or items to be stored can be hanged on the Hangaround. FIG. 3B shows the latch 21 in a closed position. The latch is in the form of a gate with one end pivotally attached to the Holding section. Another end of the latch 21 closes with a snap on the Holding section and in its closed position prevents the various items or articles from accidental detachment from the Hanging section. The Holding section has a plurality of raised portions 22. Each raised portion has an opening or eyelet 22. The opening can be of any shape, preferably a circular shape. A trough 24 is formed between adjacent raised portions.

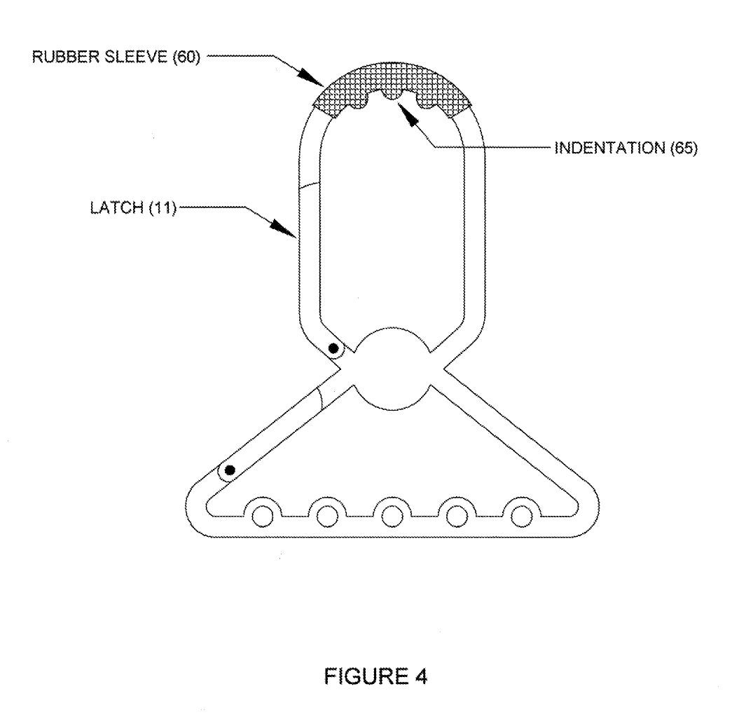

FIG. 4 shows an alternate embodiment of the Holding section 30. The embodiment is very similar to the embodiment shown in FIGS. 1-3 except that a rubber sleeve 60 is attached to a portion of the Hanging section. The sleeve may have a plurality of indentations 65 to enhance gripping power. The sleeve can be fitted onto the Attachment section when the latch 11 is in open position.

Although only limited embodiments and shapes of the instant invention have been presented and described, it is to be understood that variations of the invention will be apparent to those skilled in the art, and that the invention is limited only by the scope of the following claims.

What is claimed is:

1. A Hangaround for organizing a plurality of portable items comprising of:
an attachment section having a first interior space, a holding section integral with the attachment section and having a second interior space, a first latch opening for the first interior space, a second latch opening for the second interior space, and the attachment section hung on a support member.

2. The Hangaround according to claim 1, wherein the Hangaround is made of a material such as, but not limited to, polished aluminum, plastic and stainless steel.

3. The Hangaround according to claim 1, wherein the attachment section has an oval, rectangular or any functional shape.

4. The Hangaround according to claim 1, wherein the holding section has a triangular, rectangular or any functional shape.

5. The Hangaround according to claim 1, wherein the attachment section has a rubber sleeve with or without a plurality of indentations.

6. The Hangaround according to claim 1, wherein the holding section has a plurality of raised portions defining a trough between adjacent raised portions.

7. The Hangaround according to claim 6, wherein each of the raised portions has an opening to accommodate a fastener, a hook or a carabineer.

8. The Hangaround according to claim 1, wherein one end of the first latch is pivotally attached to the attachment section and the other end snap fits to the attachment section.

9. The Hangaround according to claim 1, wherein one end of the second latch is pivotally attached to the holding section and the other end snap fits to the holding section.

10. The Hangaround according to claim 8, wherein one end of the second latch is pivotally attached to the holding section and the other end snap fits to the holding section.

11. The Hangaround according to claim 8, wherein the attachment section and the holding section are made separately and joined together by suitable fasteners.

12. The Hangaround according to the claim 1, wherein the first and/or the second latch can be inward or outward opening.
